(19) United States
(12) Patent Application Publication
(10) Pub. No.: US 2013/0084486 A1
(43) Pub. Date: Apr. 4, 2013

(54) ELECTROCHEMICAL CELLS INCLUDING A CONDUCTIVE MATRIX

(71) Applicants: Mohamed Rahmane, Ballston Lake, NY (US); Chandra Sekher Yerramalli, Niskayuna, NY (US); Badri Narayan Ramamurthi, Clifton Park, NY (US); Andrey Meshkov, Niskayuna, NY (US); Richard Louis Hart, Broadalbin, NY (US); Michael Alan Vallance, Loudonville, NY (US); David Charles Bogdan, JR., Scotia, NY (US)

(72) Inventors: Mohamed Rahmane, Ballston Lake, NY (US); Chandra Sekher Yerramalli, Niskayuna, NY (US); Badri Narayan Ramamurthi, Clifton Park, NY (US); Andrey Meshkov, Niskayuna, NY (US); Richard Louis Hart, Broadalbin, NY (US); Michael Alan Vallance, Loudonville, NY (US); David Charles Bogdan, JR., Scotia, NY (US)

(21) Appl. No.: 13/250,680

(22) Filed: Sep. 30, 2011

(51) Int. Cl. H01M 2/14; H01M 10/04; H01M 2/02

(52) U.S. Cl. 429/163; 429/246; 29/623.1

(57) ABSTRACT

An electrochemical cell includes an outer housing, a separator for separating an anode material from a cathode material, wherein the separator is disposed in the outer housing. The electrochemical cell also includes a conductive thin sheet disposed around an outer circumference of the separator, wherein the conductive thin sheet is disposed such that it allows passage of the anode material between the separator and the conductive thin sheet. The electrochemical cell further includes a conductive matrix disposed between, and in contact with, the conductive thin sheet and the outer housing.

### BACKGROUND OF THE INVENTION

The field of the present disclosure relates generally to an electrochemical cell. More particularly, the present disclosure relates to an electrochemical cell including a conductive matrix.

Typical electrochemical cells include a casing, a negative electrode, a positive electrode, and electrolyte materials. A beta-alumina solid electrolyte (BASE) is used as a separator between the anode and cathode materials. As a ceramic material, the BASE material is somewhat fragile, and subject to damage from vibration, impacts and the like. The BASE material separator is typically placed in the case to separate an interior space of the battery into an anode compartment (e.g., between the outer circumference of the separator and the case) and a cathode compartment (e.g., inside the circumference of the separator). A cathode electrolyte material is contained within the cathode compartment and an anode material is contained within the anode compartment.

During discharge of a molten salt battery, heat is produced. A fully charged molten salt battery typically has an anode compartment that is approximately fifty percent full of molten sodium. thereby leaving an empty space (e.g., an air gap) in the anode compartment. The air gap typically does not conduct heat as well as the sodium. Thus, the cathode is at a higher temperature than the case due to inefficiencies in transmitting heat from the cathode to the case. As a battery discharges, the amount of anode material in the anode compartment is reduced, which creates an increased travel distance for the electrons during discharge and also limits the thermal cooling ability of the battery. Typically, it is not possible to increase the amount of anode material in the anode compartment because this causes pressure buildup in the anode compartment and cause cracking, rupture or failure of the battery.

To cool a cell, air is circulated around the case of the cell to remove heat from the case. Thus, heat must travel from the cathode, to the outer case of the cell in order to cool the cathode.

The conductive matrix disclosed herein facilitates one or more of improved power output, reduced internal electrical resistance, structural support and improved thermal management for electrochemical cells, such as, for example molten salt batteries.

### BRIEF DESCRIPTION OF THE INVENTION

In one aspect an electrochemical cell includes an outer housing, a separator for separating an anode material from a cathode material, the separator disposed in the outer housing, a conductive thin sheet disposed around an outer circumference of the separator, the conductive thin sheet disposed such that it allows passage of the anode material between the separator and the conductive thin sheet, and a conductive matrix disposed between and in contact with the conductive thin sheet and the outer housing.

In another aspect, an anode structure for an electrochemical cell includes a separator that separates an anode compartment from a cathode, a conductive matrix disposed in the anode compartment, the conductive matrix in contact with the separator and an outer housing of the electrochemical cell.

In a further aspect, a method of assembling an electrochemical cell includes providing an outer housing, separating the housing into a cathode compartment and an anode compartment using a separator, and providing a conductive matrix in the anode compartment between the separator and the housing.

### BRIEF DESCRIPTION OF THE DRAWINGS

FIG. 1 shows a partial internal view of an exemplary embodiment of an electrochemical cell according to the present disclosure.

FIG. 2 shows a partial internal view and heat transfer path of an exemplary embodiment of an electrochemical cell according to the present disclosure.

FIGS. 3A and 3B show a partial top view of an internal part of exemplary embodiments of an electrochemical cell according to the present disclosure.

FIG. 4 shows a partial top view of an internal part of an exemplary embodiment of an electrochemical cell according to the present disclosure.

FIG. 5 shows a perspective view of a battery incorporating an electrochemical cell according to the present disclosure.

FIG. 6 shows a cross-section of a battery incorporating an electrochemical cell according to the present disclosure.

FIGS. 7 and 8 show perspective views of a cooling structure for an electrochemical cell according to the present disclosure.

FIG. 9 shows a cell discharge current as a function of time.

FIG. 10 shows a thermal profile of a electrochemical cell at various states of discharge.

FIG. 11 is a plot of the cell thermal profile of FIG. 10 as a function of time during discharge.

FIG. 12 is a graph of delta temperature of the cathode to the case as a function of time during cell discharge.

FIG. 13 is a graph showing discharge time versus cycle number at 155 W power output.

FIG. 14 is a graph showing cell voltage at the end of a 15 minute discharge at various cycles.

FIG. 15 is a graph showing cell resistance measured at 22 Ah at a particular discharge cycle.

FIG. 16 is a graph showing discharge time from full charge to 1.8V at various output powers.

FIG. 17 shows a temperature profile of an electrochemical cell according to the present disclosure.

FIG. 18 shows a temperature profile of a cross section of the electrochemical cell of FIG. 17.

FIG. 19 is a cross-sectional view showing an electrochemical cell according to the present disclosure.

FIG. 20 shows a plot of relative cathode temperature during a discharge cycle of an electrochemical cell.

### DETAILED DESCRIPTION OF THE INVENTION

Described herein are electrochemical cells incorporating a conductive matrix allowing for the possibility of one or more of improved thermal transfer, reduced internal resistance, increased power output, improved separator support and increased electrolyte contact area.

In one embodiment, a conductive matrix is configured for use with existing cell designs, for example, by retrofitting. In another embodiment, the conductive matrix is configured for cell designs manufactured specifically to incorporate the conductive matrix of the present disclosure. The conductive matrix of the present disclosure is configured to fill all or a portion of the anode compartment by a conductive (thermally and/or electrically) structure such that thermal and/or electrical contact is maintained between a cell core and a cell case.

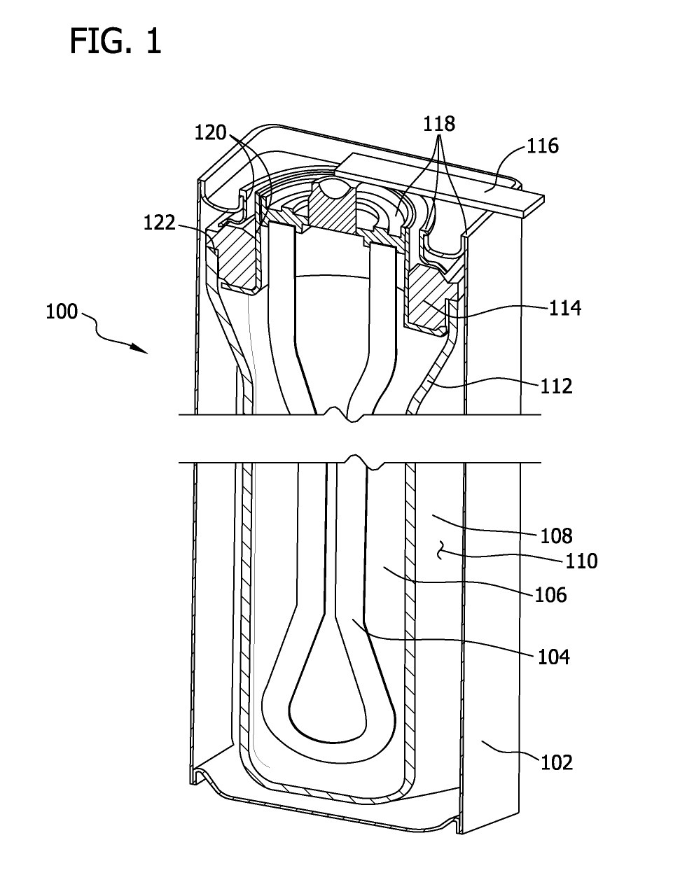

Shown generally in FIG. 1 is an exemplary embodiment of an electrochemical cell 100. The electrochemical cell 100 includes a case 102, a current collector 104, a cathode material 106, an anode chamber 108, an anode material 110, a separator 112, a collar 114, an interconnect 116, a connected portion 118, a conductive ring structure 120 and a seal 122. Apart from certain exceptions detailed herein, the components of the electrochemical cell may, in general, be prepared of materials, and using techniques, generally known in the art that allow the electrochemical cell to function according to the present disclosure.

During a discharge cycle of electrochemical cell 100, ions migrate from anode material 110 contained within anode chamber 108 through separator 112 to cathode material 106, to current collector 104. In one embodiment, the case 102 also functions as an anode current collector (i.e., a negative pole of the electrochemical cell). In another embodiment, anode material 110 only fills a portion of anode chamber 108, and anode material 110 is only in contact with a portion of separator 112. For example, a fully charged electrochemical cell has a volume of anode material capable of filling anode chamber 108, for example, 40-60%, particularly 45-55% and more particularly, 50% of the vertical distance of separator 112. The transfer of ions occurs at the contact area of anode material 110 with separator 112.

In one embodiment, an anode contact layer (not shown) of conductive porous particles or material applied as a thin layer <0.5 mm thick is applied between the separator 112 and other layers of the cell 100. The anode contact layer is a carbon layer, which may be applied as an aqueous paint/slurry bonded to the separator 112 using sodium phosphate glass binder. However, the an anode contact layer may be any material that allows the cell 100 to operate as described herein.

Typically, it is not possible to provide a volume of anode material 110 to fill anode chamber 108 to 100% of the vertical distance of separator 112 due to the possibility of high pressures that may build during charging and/or discharging cycles of electrochemical cell 100. In some embodiments, the anode volume is not filled to 100% to provide an available volume for anode material 110 (e.g., sodium) to flow in and out of the anode chamber 108 as the cell 100 is charged and discharged.

A discharge power of electrochemical cell 100 is dependent upon an area of anode material 110 contacting separator 112. An increased area of anode material 110 contacting separator 112 increases the amount of power that is produced by cell 100, and a decreased area of anode material contacting separator 112 decreases the amount of power produced by cell 100.

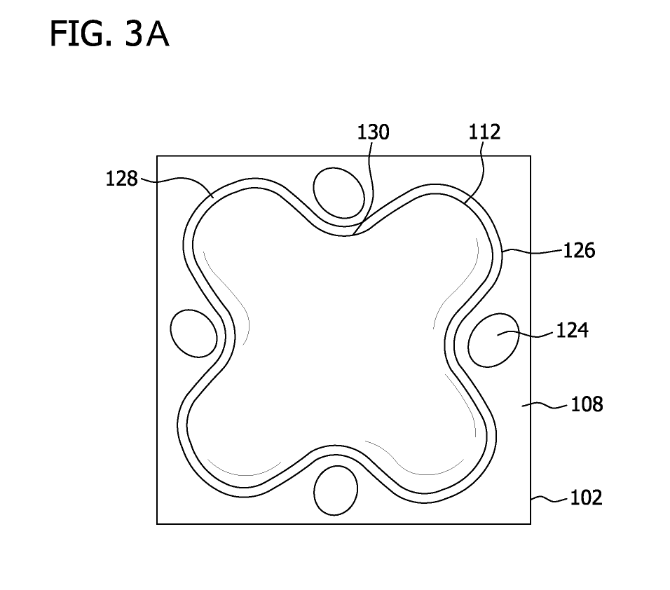

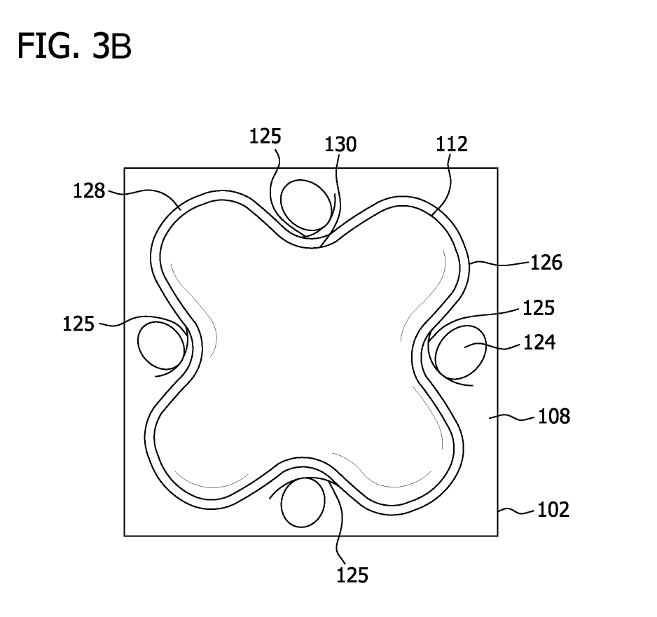

In one embodiment (e.g., FIG. 3A), to facilitate an increase in an amount of anode material 110 contacting separator 112, a conductive matrix comprising at least one of a shim portion 124 (shown in FIG. 3A) and a conductive thin sheet layer 126, is provided in anode chamber 108 of electrochemical cell 100. In another embodiment, the conductive matrix is provided in at least a portion of anode chamber 108 between separator 112 and case 102. In yet another embodiment, the conductive matrix is configured to provide a transport mechanism that transports anode material 110 along separator 112 to increase a contact area of anode material 110 with separator 112. In yet another embodiment, the conductive matrix is configured to provide a capillary action that facilitates transport of anode material 110 along separator 112 and increases the contact area of anode material 110 with separator 112. In another alternative embodiment (e.g., FIG. 3B), shim portion 124 may be attached to layer 126 by connecting sections 125, for example.

FIG. 3A illustrates an exemplary conductive matrix comprising a conductive thin sheet 126 disposed around an outer circumference of separator 112. Conductive thin sheet 126 is comprised of a conductive material such as a metal, metal foil or the like, for example, nickel, copper, aluminum or other conductive metals having a melting temperature greater than a melting temperature of anode material 110. In one embodiment, conductive thin sheet 126 is disposed such that it allows passage of anode material 110 between separator 112 and conductive thin sheet 126. In other embodiments, conductive thin sheet 126 is wrapped around separator 112 such that a space between conductive thin sheet 126 and separator 112 is approximately equal to, or less than, 1 mm.

In one embodiment, conductive thin sheet 126 is configured to be flexible enough to allow inflowing anode material 110 to flow into the space. For example, conductive thin sheet 126 is formed such that it closely conforms to a shape of the outer surface of separator 112. The space between separator 112 and conductive thin sheet 126 facilitates a transporting and/or capillary action that allows anode material 110 to flow into the space and contact a greater area of separator 112 than is possible without conductive thin sheet 126. In another embodiment, conductive thin sheet 126 facilitates a uniform distribution of anode material 110 over areas of separator 112. The increased contact area facilitates an increase in charge transfer in initial stages of a charging process of electrochemical cell 100, when little or no anode material 110 is present in anode chamber 108. For example, even a small amount of anode material 110 present in anode chamber 108 is transported up along separator 112 in the space formed between conductive thin sheet 126 and separator 112 during the initial stages of charging.

In one embodiment, the conductive matrix comprises a shim portion 124 disposed directly or indirectly between separator 112 and case 102. In another embodiment, shim portion 124 is disposed between conductive thin sheet 126 and case 102. In yet another embodiment, conductive thin sheet 126 and shim portion 124 are formed as a single member. Shim portion 124 is made of an electrically and/or thermally conductive material that is the same as, or different from, the material of conductive thin sheet 126. In some embodiments, shim portion 124 is comprised of at least one of metallic wool, an interconnected matrix of metal strips, fibers, wires, sintered particles, a porous metallic structure, a metallic foam and the like. In yet other embodiments, shim portion 124 is comprised of one or more of a copper wool, steel, carbon, copper, iron based alloys such as FeCrAlY, or other lightweight conductive materials that are compatible with an anode material of electrochemical cell 110.

In one embodiment, shim portion 124 is comprised of an aluminum foam having a minimum foam porosity of approximately 55% and a foam density of 1.2 grams per cubic centimeter. In another embodiment, shim portion 124 is comprised of a metallic foam or wool having approximately 50%-80% porosity. The metallic foam or wool is disposed in approximately 50%-100% of the anode chamber.

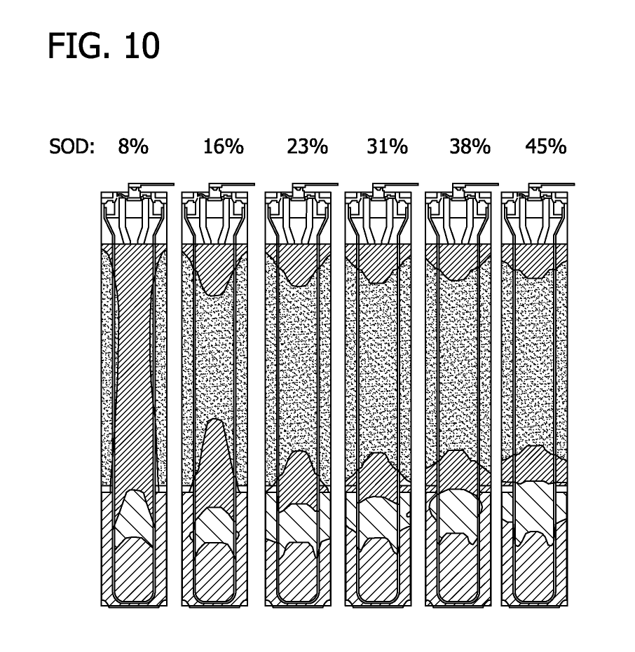

In one embodiment, the conductive matrix comprises a compressible shim portion 124 that provides a spring force/pressure against separator 112 and case 102 to provide structural support for separator 112. In some embodiments, separator 112 is comprised of a BASE material. In another embodiment, shim portion 124 is configured to provide sufficient contact between separator 112 and case 102 to provide separator 112 with dimensional stability thereby preventing, or substantially preventing, possible movement of separator 112 within electrochemical cell 100. In yet another embodiment, shim portion 124 is configured to provide a reduction in transference of vibration from case 102 to separator 112. In still another embodiment, shim portion 124 is electrically conductive to provide electrical contact between separator 112 and case 102 to reduce an internal resistance of electrochemical cell 100, for example by an amount of 0.0005 Ohms at 22 Ah (FIG. 10).

In one embodiment, electrochemical cell 100 is a molten salt battery including sodiumaluminumchloride (NaAlCl₄) as the electrolyte, which melts (i.e. becomes molten) at approximately 157° C. In another embodiment, electrochemical cell 100 includes nickel (Ni) as a positive electrode material and sodium as a negative electrode material.

In one embodiment, separator 112 is formed in an irregular shape (e.g., non-symmetric). In another embodiment, separator 112 is formed as a regular (e.g., symmetric) shape, such as a cloverleaf shape, having one or more convex sections 128 and one or more concave sections 130, as shown in FIG. 3A.

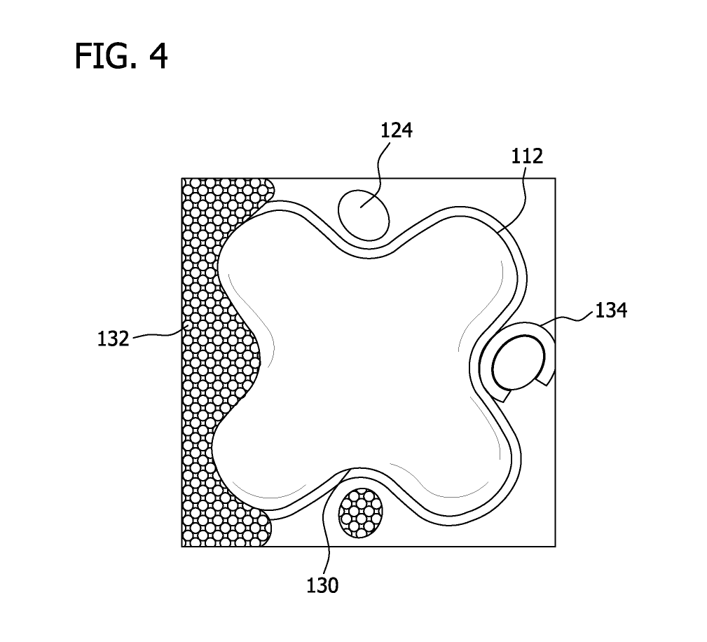

In one embodiment, conductive matrix 124 is disposed in one or more of concave sections 130, for example, as shown in FIG. 4. In another embodiment, conductive matrix 124 is disposed around concave sections 130 and convex sections 128 of separator 112, for example as shown at numeral 132 in FIG. 4. In yet another embodiment, conductive matrix 124 is formed of a bent shape 134 and provided at one or more of concave sections 130. Bent shape 134 is formed with a thickness that facilitates sufficient heat transfer from the cathode to case 102 to allow electrochemical cell 100 to function as disclosed herein.

In one embodiment, conductive matrix 124 fills, by volume, approximately 50 percent of anode chamber 108. In another embodiment, conductive matrix extends from a bottom of anode chamber 108 to a top of anode chamber 108 to facilitate transport of anode material 110 along an entire height of separator 112.

In one embodiment, an outer conductive layer is disposed around shim portion 124 of the conductive matrix. The outer conductive layer facilitates installation of the conductive matrix, for example, by holding together portions of the conductive matrix during installation. In another embodiment, after the conductive matrix has been installed in electrochemical cell 100, the outer conductive layer is removed and may be reused for subsequent installation procedures. In another embodiment, each of shim portions 124 are individually wrapped in an outer conductive layer. Alternatively, one or more of shim portions 124 are wrapped together in an outer conductive layer. The outer conductive layer is formed of a material that is the same as, or different from, the conductive thin sheet.

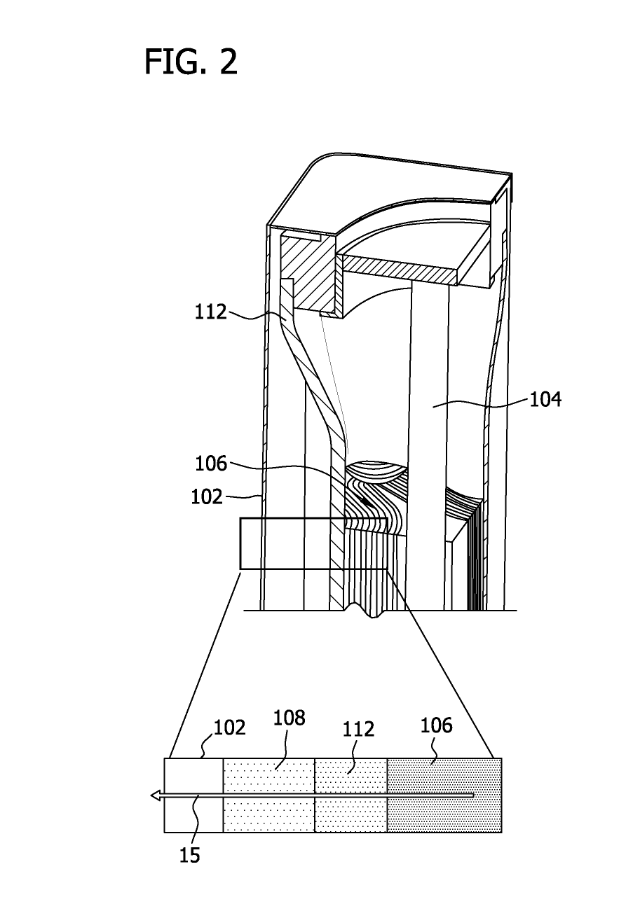

Electrochemical cells, such as molten salt electrochemical cells, function optimally within a specific range of temperatures. Molten salt batteries operate at temperatures of approximately 240° C. to 700° C., particularly between 245° C. to 350° C. or between 400° C. to 700° C. For example, the optimal operating temperature of a Na—NiCl₂ battery may be 300° C., when measured at the cathode. In one embodiment, the temperature of the battery is maintained within about a 50° C. range, for example, between 280° C. and 330° C. As shown in FIG. 2, the heat generated by cathode 106 travels in a heat path 15 extending from the cathode material 106, through separator 112, through anode chamber 108 (including anode material 110) and to case 102. Thus, to keep electrochemical cell 100 operating at its optimal temperature, excess heat produced during discharge is managed to maintain a desired temperature of the case and/or cathode. In one embodiment, the conductive matrix facilitates thermal transfer between the cathode and the case, thereby allowing for the possibility of additional heat transfer out of electrochemical cell 100. In another embodiment, the conductive matrix facilitates rapid and/or uniform transfer of heat from the cathode to the case such that the difference in temperature between the cathode and the case is maintained within a range of temperatures, for example, a 50 degree range.

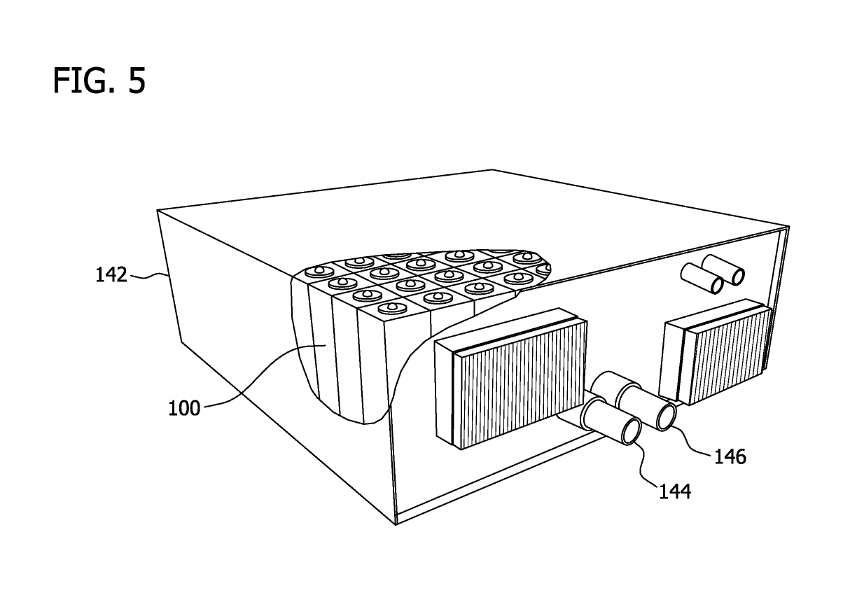

In one embodiment, a plurality of electrochemical cells are electrically connected to form a battery pack 1, which is contained within a battery case 142, as shown in FIG. 5. In another embodiment, 220 electrochemical cells are connected in battery pack 1. Electrochemical cells of battery pack 1 are connected in series or parallel, or a combination thereof. In another embodiment, battery pack 1 comprises a cooling inlet 144 and a cooling outlet 146 that allows for a cooling medium to be circulated around electrochemical cells 100.

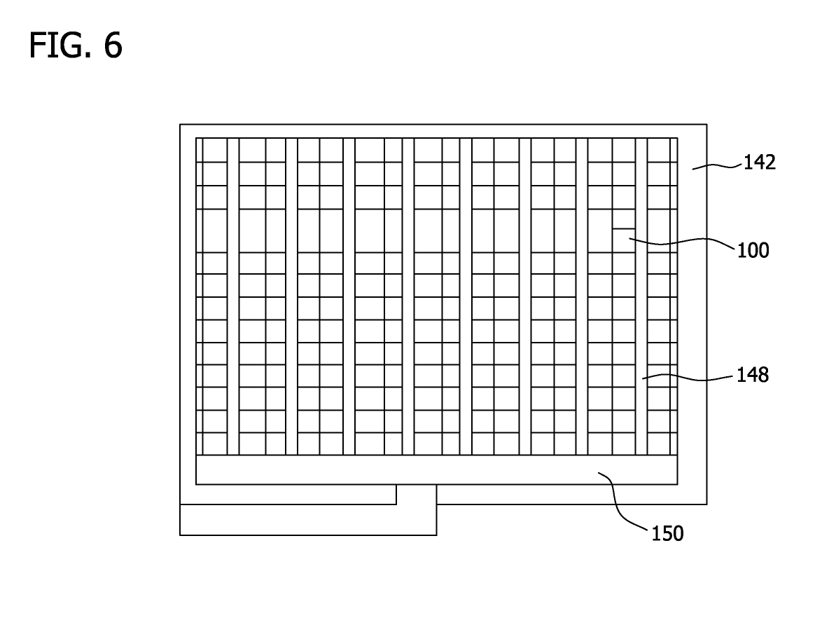

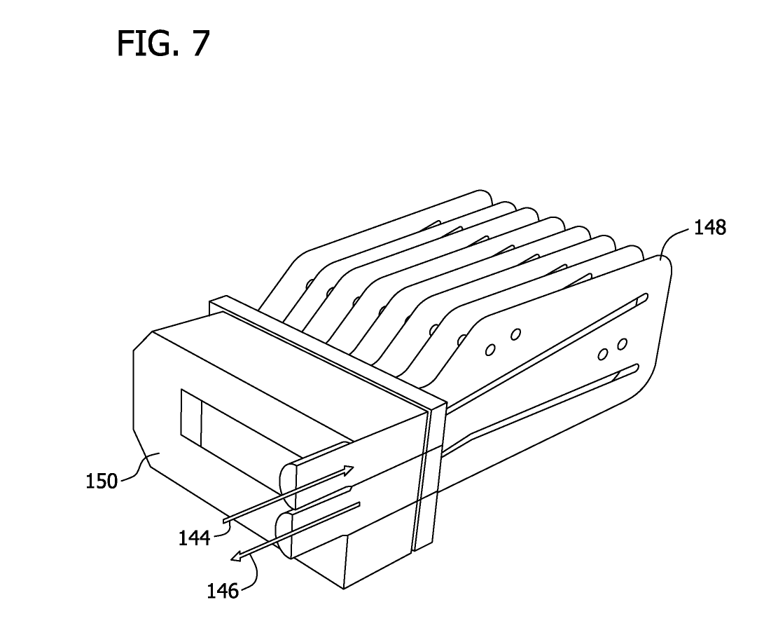

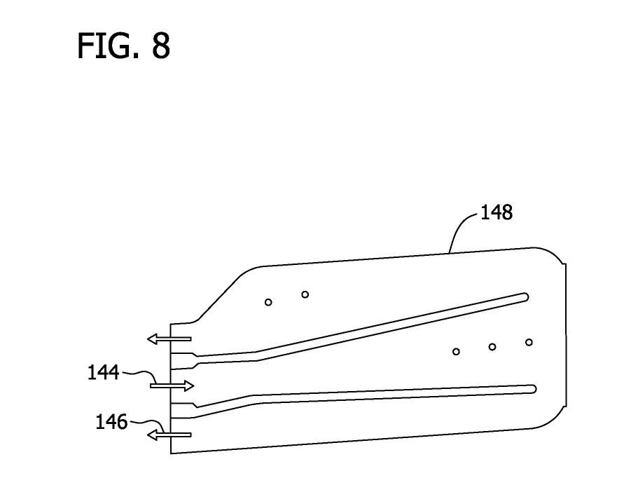

In one embodiment, battery pack 1 further comprises cooling fins 148 disposed between one or more rows of electrochemical cells 100, as shown, for example in FIG. 6. In another embodiment, cooling fins 148 are connected via a manifold 150 that provides a common supply of cooling medium to cooling fins 148. In yet another embodiment, cooling inlet 144 and cooling outlet 146 are connected to manifold 150, as shown in FIG. 7, to facilitate substantially even distribution of cooling medium amongst cooling fins 148. In yet another embodiment, for example as shown in FIG. 8, cooling fins 148 are provided with a single inlet 144 and two or more outlets 146 to improve the flow of cooling medium.

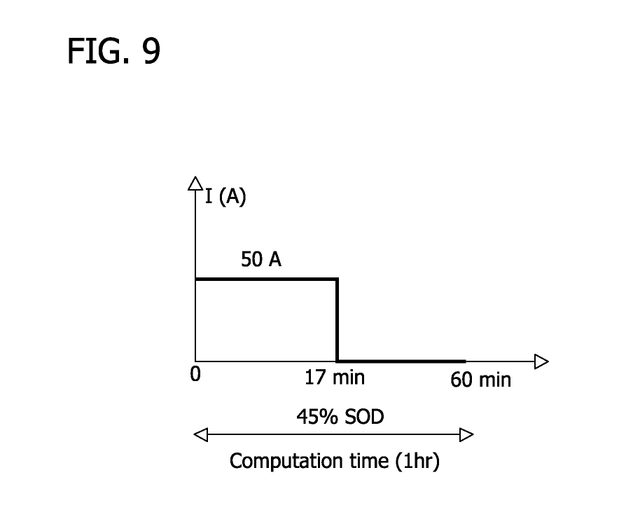

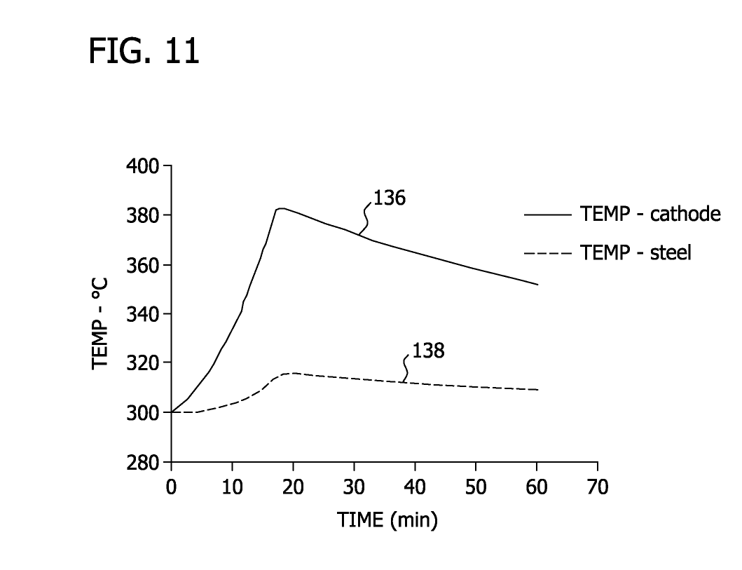

During a discharge cycle, an electrochemical cell generates heat. A heat profile of a known electrochemical cell not including a conductive matrix according to the present disclosure is provided at increasing states of discharge is shown in FIG. 9. As shown in FIG. 10, as the state of discharge increases, the cathode (shown as the center area of the cells) becomes hotter, and the heat profile becomes less uniform across a cross-section of electrochemical cell 100. FIG. 11 shows the temperature of cathode 136 as a function of time, as compared to the temperature of steel case 138 of a known electrochemical cell. As shown in FIG. 11, the difference in temperature between the cathode and the case becomes larger during the discharge phase. The discharge operation was halted after approximately 17 minutes, and thus the temperature of the cathode and the case steadily decrease after the 17 minute mark, as shown in FIG. 11.

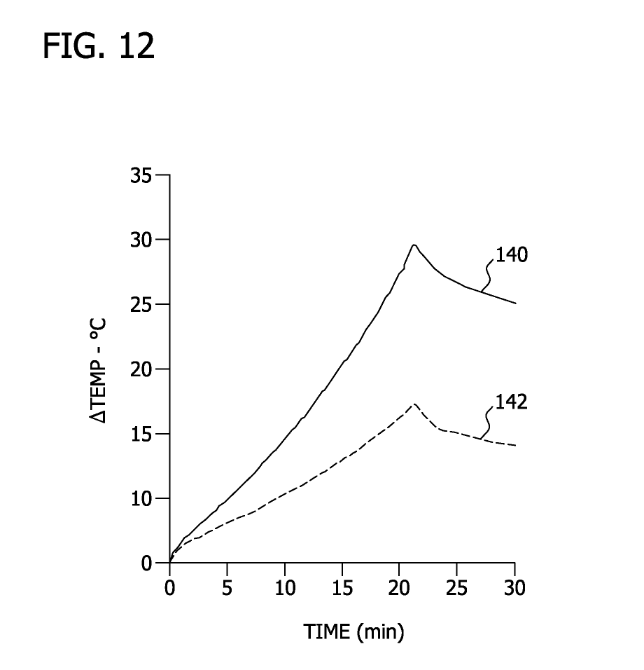

FIG. 12 plots a difference in temperature 140 between the cathode and the case of an electrochemical cell having no conductive matrix, as a function of time during a discharge cycle. Indicated at numeral 142 is a plot of a difference in temperature between the cathode and the case of an electrochemical cell having a known rigid (non compressible) hollow metal shim, as a function of time during a discharge cycle. As shown in FIG. 12, in an electrochemical cell having no shims, the difference in temperature 140 reaches approximately 30 degrees. When utilizing known shims, the difference in temperature 142 reaches approximately 17 degrees.

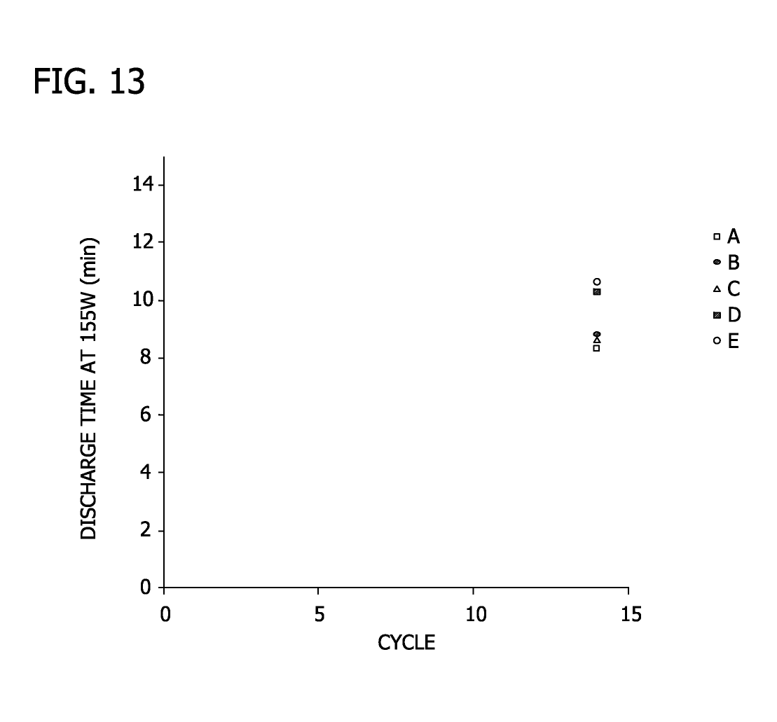

FIG. 13 plots a comparison of discharge time at 155 watts of known electrochemical cells A, B and C not including a conductive matrix according to the present disclosure, compared to electrochemical cells D and E including a conductive matrix according to the present disclosure. Electrochemical cells A, B and C are typical electrochemical cells without a conductive matrix according to the present disclosure. As shown in FIG. 13, cells D and E, incorporating a conductive matrix according to the present disclosure, sustained a longer discharge time at a power of 155 W than electrochemical cells A, B and C.

The term “cycle” as used herein refers to an electrochemical cell being fully charged and then undergoing a discharge for a predetermined time.

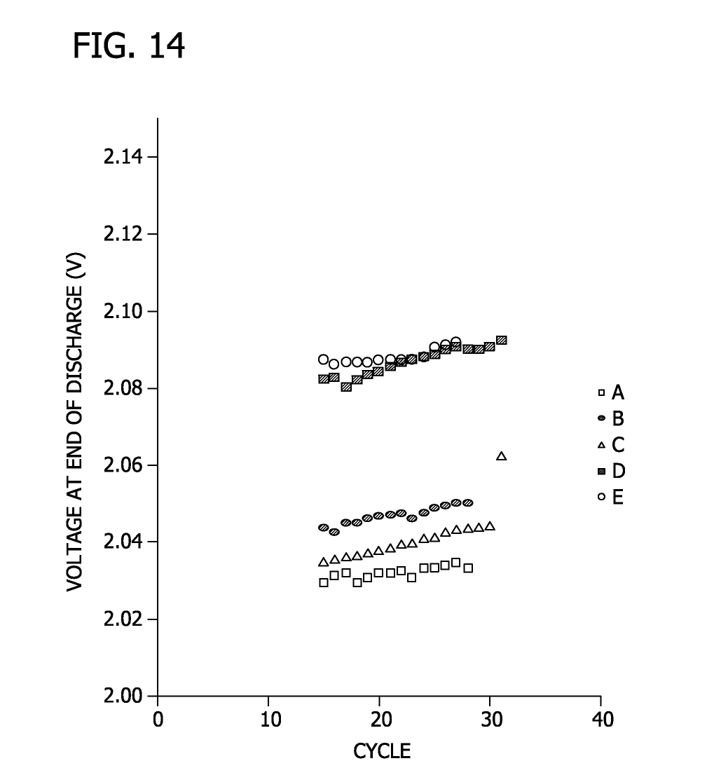

FIG. 14 plots the voltage at the end of multiple 15 minute discharge cycles at a discharge power of 110 W for known cells A, B and C, and cells D and E according to the present disclosure. Electrochemical cells D and E, incorporating a conductive matrix according to the present disclosure, showed increased voltage at the end of each discharge cycle as compared to cells A, B and C.

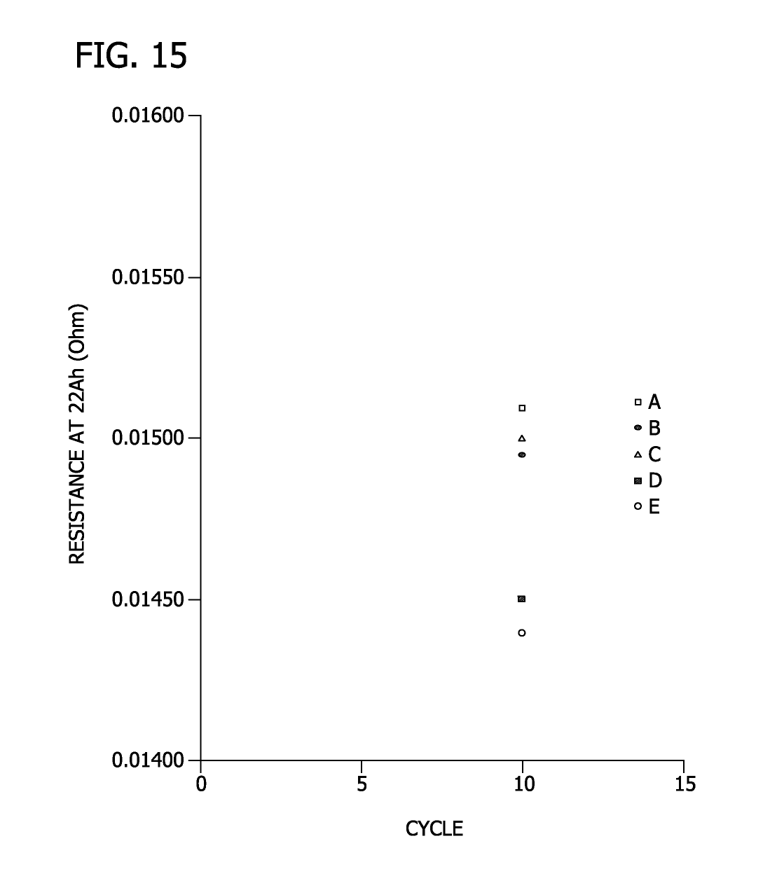

FIG. 15 plots resistance at a discharge of 22 Ah at the 10^{th} discharge cycle for known cells A, B and C, and cells D and E according to the present disclosure. Electrochemical cells D and E, incorporating a conductive matrix according to the present disclosure, showed reduced resistance as compared to cells A, B and C.

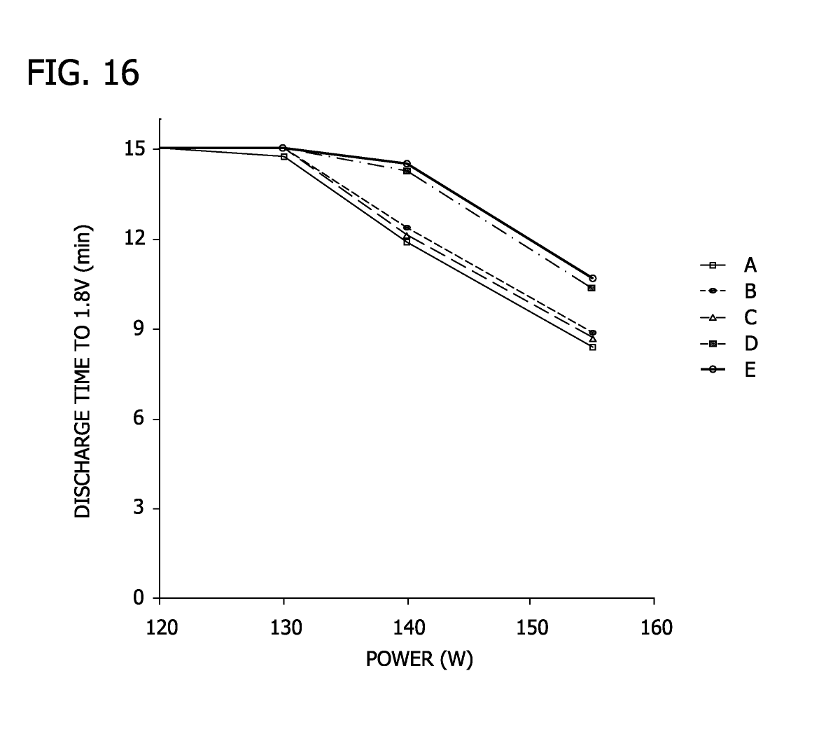

FIG. 16 shows a plot of discharge time from full charge to 1.8V at a sampling of different power outputs for known cells A, B and C, and cells D and E according to the present disclosure. Cells D and E, incorporating a conductive matrix according to the present disclosure, showed increased discharge time for power levels over 130 W, as compared to cells A, B and C.

In one embodiment, electrochemical cell 100 includes case 102 of any shape that allows electrochemical cell 100 to function in accordance with the present disclosure, for example a polygonal shape, a cylindrical shape and the like. In one embodiment, case 102 has dimensions of approximately 36 mm×36 mm×230 mm. In another embodiment, separator 112 has a height of approximately 220 mm.

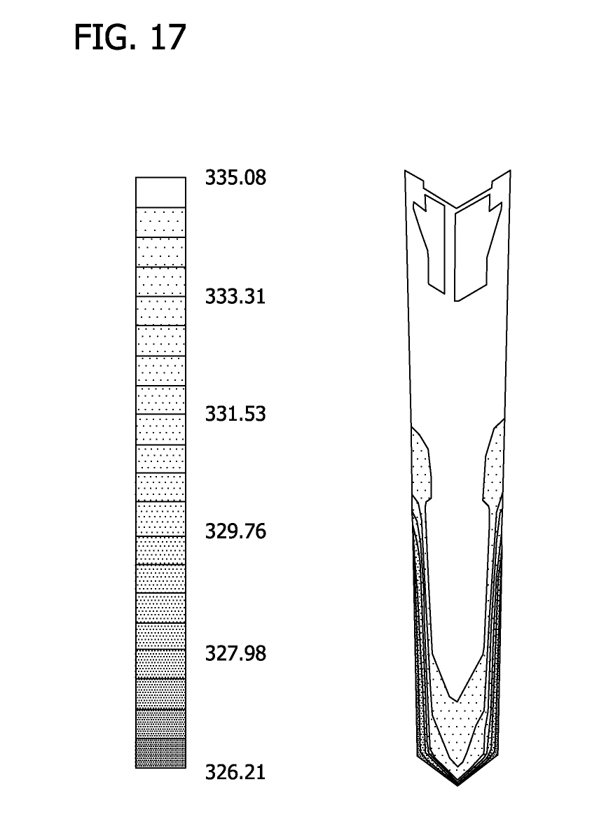

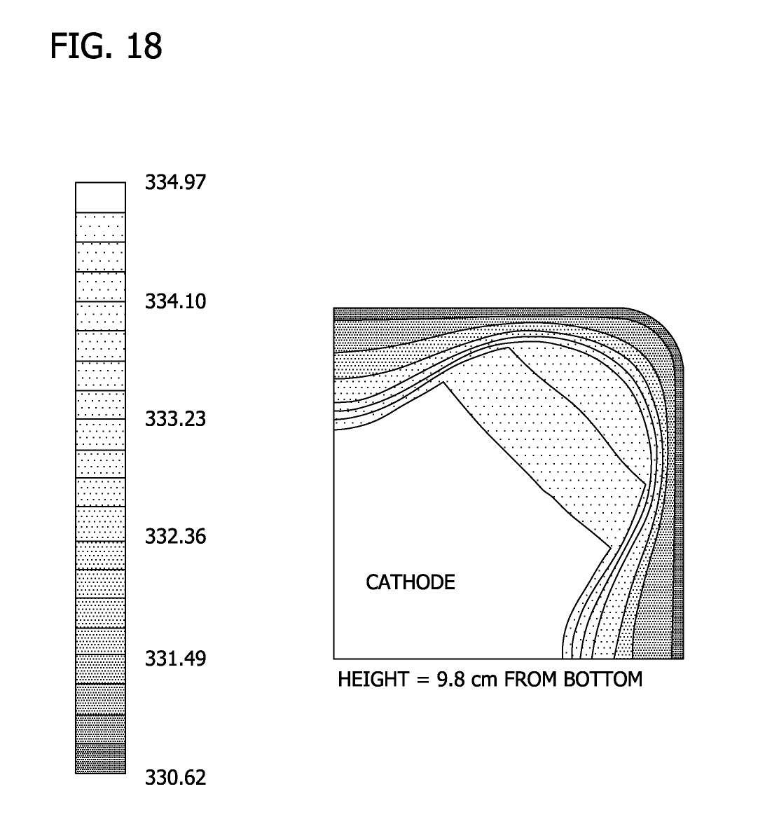

FIG. 17 shows a temperature profile of a case 102 of electrochemical cell 100 including shim portion 124 comprised of a 60% porous aluminum foam. As shown in FIG. 17, at the end of a discharge cycle, the temperature of case 102 ranged from 335.08° C. to 326.21° C. FIG. 18 shows a thermal profile of a cross-section taken at 9.8 cm from the bottom of electrochemical cell 100 shown in FIG. 18. As shown in FIG. 17, the temperature difference from the cathode to the case is approximately 5° C., when measured at the end of a discharge cycle.

Moreover, the conductive matrices described for embodiments of this invention may be used with other types of shim structures for electrochemical cells. Non-limiting examples of those other types of structures are provided in pending application Ser. No. 13/173320, filed on Jun. 30, 2011, and assigned to the present Assignee; and U.S. Patent Application Publication No. 2010/0178546, Job Rijssenbeek et al. Both of these references are incorporated herein by reference in their entirety.

### EXAMPLE

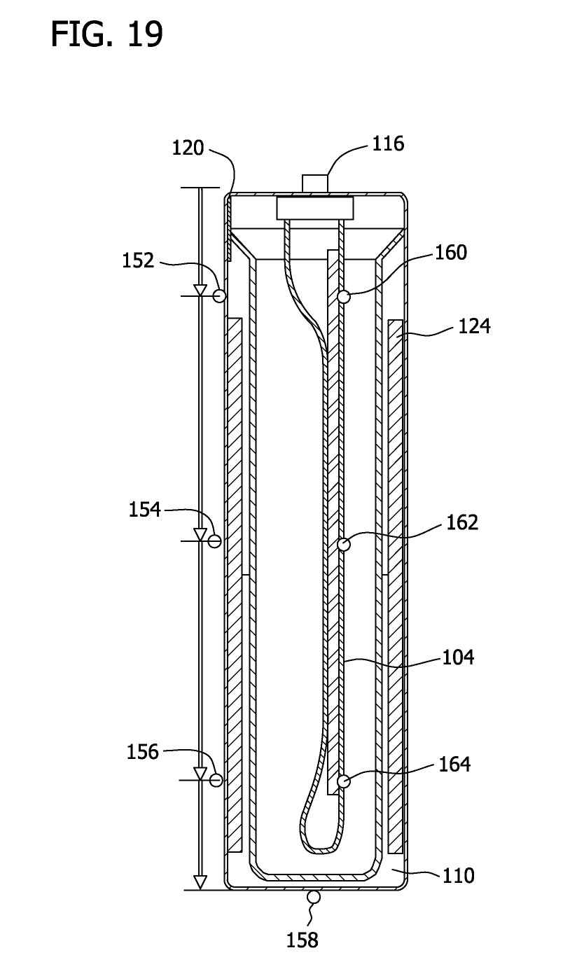

Depicted in FIG. 19 is an electrochemical cell set up for experimentation including a shim portion 124 according to the present disclosure. Shim portion 124 for the experiment was a solid steel rod. Single cell temperature measurements were conducted using seven temperature sensors 152, 154, 156, 158, 160, 162 and 164. Temperature sensors 160, 162 and 164 are located along the cathode and temperature sensors 152, 154, 156, and 158 are located on the case. Sensors 152, 154 and 156 were located at approximately 1.5″, 4.25″, 7″ from the top of the cell, respectively. Sensor 158 was placed at the bottom of the cell. Sensors 160, 162 and 164 were placed at approximately 1.5″, 4.25″, 7″ from the top of the cell, respectively.

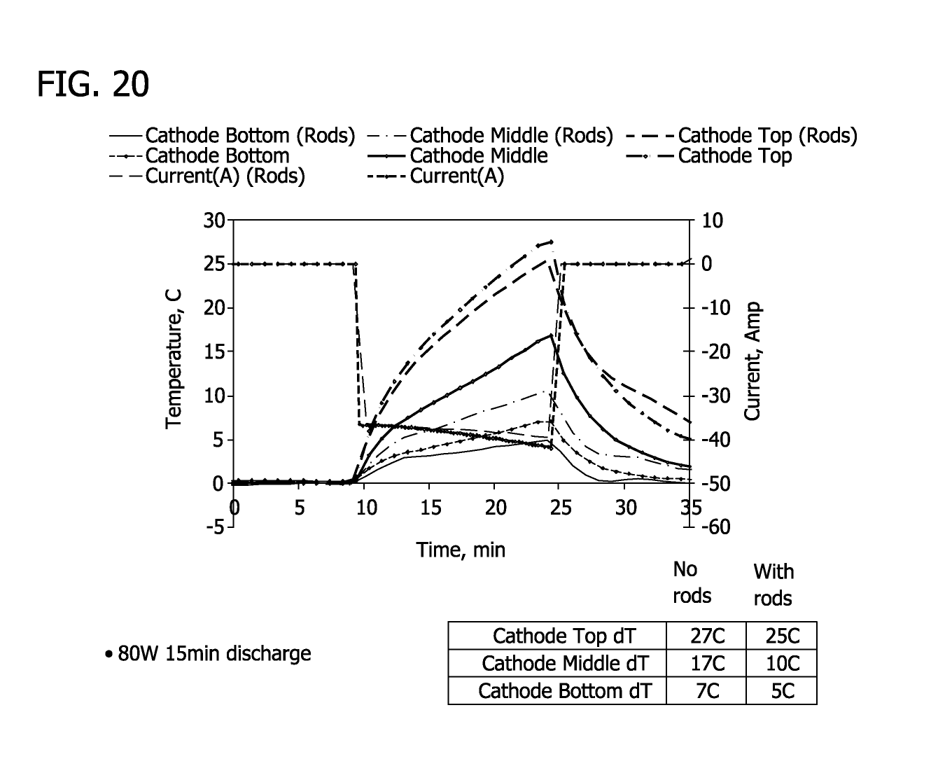

A discharge cycle was conducted at 80 W for 15 minutes, during which time the cell heating was adjusted to maintain sensor 154 at a temperature of 300° C. Shown in FIG. 20 is a plot of the temperature of sensors 160, 162 and 164 as a function of time during discharge. At the end of the 15 minute cycle, the temperature difference from sensors 160, 162 and 164 to the 300° C. case temperature was 25° C., 10° C., and 5° C., respectively.

### COMPARATIVE EXAMPLE

A similar experiment was run using an electrochemical cell without the inclusion of shim portion 124 (i.e., no steel rods were inserted). Temperature sensors 152-164 were set up as shown in FIG. 19 in a manner similar to the above described Example.

A discharge cycle was conducted at 80 W for 15 minutes, during which time the cell heating was adjusted to maintain sensor 154 at a temperature of 300° C. Shown in FIG. 20 is a plot of the temperature of sensors 160, 162 and 164 as a function of time during discharge. At the end of the 15 minute cycle, the temperature difference from sensors 160, 162 and 164 to the 300° C. case temperature was 27° C., 17° C. and 7° C., respectively.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electrochemical cell, comprising:
an outer housing;
a separator for separating an anode material from a cathode material, the separator disposed in the outer housing;
a conductive thin sheet disposed around an outer circumference of the separator, the conductive thin sheet disposed such that it allows passage of the anode material between the separator and the conductive thin sheet; and
a conductive matrix disposed between, and in contact with, the conductive thin sheet and the outer housing.

2. An electrochemical cell according to claim 1, wherein the conductive thin sheet and the conductive matrix are a single member.

3. An electrochemical cell according to claim 1, wherein the conductive matrix comprises at least one of a metallic wool, an interconnected matrix of metal strips, fibers, wires, wool, conductive particles or agglomerates, a porous metallic structure and a metallic foam.

4. An electrochemical cell according to claim 1, wherein the separator has at least one concave section and at least one convex section facing the housing, and the conductive matrix is disposed between the at least one concave section and the outer housing.

5. An electrochemical cell according to claim 1, wherein a second conductive thin sheet layer is disposed between the conductive matrix and the outer housing.

6. An electrochemical cell according to claim 5, wherein at least one of the conductive thin sheet layer and the second conductive thin sheet layer is a metal foil and the conductive matrix is a metal wool.

7. An electrochemical cell according to claim 1, wherein the conductive thin sheet surrounds substantially the entire outer surface of the separator and the conductive matrix extends from a bottom of the separator to a top of the separator.

8. An electrochemical cell according to claim 1, wherein the conductive matrix is compressible and provides a spring force against the separator and the outer case.

9. An anode structure for an electrochemical cell, comprising:
a separator that separates an anode compartment from a cathode; and
a conductive matrix disposed in the anode compartment, the conductive matrix contacting the separator and an outer housing of the electrochemical cell.

10. The anode structure according to claim 9, wherein the conductive matrix occupies up to, and including, approximately 80% by volume of the anode compartment.

11. The anode structure according to claim 9, wherein the conductive matrix comprises at least one of a metallic wool, an interconnected matrix of metal strips, fibers, wires, sintered particles, a porous metallic structure and a metallic foam.

12. The anode structure according to claim 9, wherein the conductive matrix is thermally and electrically conductive.

13. The anode structure according to claim 9, wherein the separator has at least one concave section and at least one convex section facing the housing, and the conductive matrix is disposed between the at least one concave section and the outer housing.

14. The anode structure according to claim 13, wherein the conductive matrix is disposed between the at least one convex section and the housing.

15. The anode structure according to claim 9, further comprising a conductive thin sheet disposed around an outer circumference of the separator.

16. The anode structure according to claim 15, further comprising a second conductive thin sheet disposed around an outer circumference of the conductive matrix.

17. A method of assembling an electrochemical cell, comprising:
providing an outer housing;
separating the housing into a cathode compartment and an anode compartment using a separator; and
providing a conductive matrix in the anode compartment between the separator and the housing.

18. The method of assembling an electrochemical cell according to claim 17, further comprising providing a conductive thin sheet disposed around an outer circumference of the separator, the conductive thin sheet disposed such that it allows passage of an anode material between the separator and the conductive thin sheet.

19. The method of assembling an electrochemical cell according to claim 17, wherein the conductive matrix is compressible and provides a spring force against the separator and the housing.

20. The method of assembling an electrochemical cell according to claim 17, wherein the conductive matrix extends from a bottom of the separator to a top of the separator.
